(19) United States
(12) Patent Application Publication
(10) Pub. No.: US 2011/0161150 A1
(43) Pub. Date: Jun. 30, 2011

(54) METHODS AND SYSTEMS PROVIDING A MULTI-MERCHANT REWARDS PLATFORM

(76) Inventors: Marc Steffens, San Francisco, CA (US); Praveen K. Jayaraman, Santa Clara, CA (US); Amit Gupta, San Jose, CA (US)

(21) Appl. No.: 12/755,209

(22) Filed: Apr. 6, 2010

Related U.S. Application Data
(60) Provisional application No. 61/290,832, filed on Dec. 29, 2009.

(51) Int. Cl. G06Q 30/00

(52) U.S. Cl. 705/14.25; 705/14.28

(57) ABSTRACT

Methods and systems for providing a multi-merchant rewards platform are discussed. In an example, a system can include an administration interface, a user tracking module, a rewards engine, and a database. The administration interface can receive a campaign rule from a merchant registered within an online marketplace. The user tracking module can identify a user accessing the online marketplace from a remote computer system. The rewards engine can determine, while the user is accessing the online marketplace, whether the user satisfies the campaign rule and calculate, based on the determination that the user satisfies the campaign rule, a non-monetary point allocation associated with a user action. The rewards engine can also receive input from the user indicating selection of the user action. The database can store the non-monetary point allocation associated with the user action.

### CROSS-REFERENCE TO RELATED PATENT DOCUMENTS

This patent application claims the benefit of priority, under 35 U.S.C. Section 119(e), to U.S. Provisional Patent Application Ser. No. 61/290,832, entitled “Methods and Systems Providing a Multi-Merchant Rewards Platform,” filed on Dec. 29, 2009, which is hereby incorporated by reference in its entirety.

### TECHNICAL FIELD

This application relates generally to commercial transactions over a distributed network, and more specifically to methods and systems for enabling multiple merchants to use a common loyalty rewards network.

### BACKGROUND

Rewards or loyalty programs are used within various industries to incent customers to continue to use a specific brand, shop within a certain chain, user a certain credit card, or fly with a certain airline. For example, many credit card companies offer cash-back or some similar incentive for using the card for purchases. The reward offers are typically based on transaction volume. Another common rewards or loyalty program is provided by most major airlines, (e.g., frequent flyer programs), which reward travelers based on miles or segments flown on a certain airline.

Rewards programs offered by retailers, airlines, or credit card companies are closed communities. For example, using a credit card that offers rewards points a customer receives a set kick-back or rebate for transactions with any merchant. An individual merchant cannot use the credit card provider's rewards program to promote the merchant's products or services. Some retailer's have their own rewards programs, which are typically linked to credit cards issued by the retailer (e.g., Best Buy, Inc. of Richfield, Minn. offers Reward Zone). However, most retail companies are too small to support a rewards program on their own.

### BRIEF DESCRIPTION OF THE DRAWINGS

Some embodiments are illustrated by way of example and not limitation in the figures of the accompanying drawings in which:

FIG. 1 is a block diagram illustrating an example architecture for a network-based marketplace within which methods and systems to provide a multi-merchant rewards platform can be implemented;

FIG. 2 is a block diagram illustrating multiple applications that, in one example embodiment, provided as part of the network-based marketplace some of which can be used to provide a multi-merchant rewards platform, among other things;

FIG. 3 is a block diagram illustrating an example system to provide a multi-merchant rewards platform;

FIG. 4 is a block diagram illustrating an example rewards engine component of a multi-merchant rewards platform;

FIG. 5 is a flowchart illustrating an example method for providing a non-monetary point allocation associated with a particular merchant to a user;

FIG. 6 is a flowchart illustrating an example method for rewarding a user with a non-monetary point allocation associated with a particular merchant;

FIG. 7 is a flowchart illustrating an example method for creating a merchant campaign within a rewards program;

FIG. 8 is a flowchart illustrating an example method for creating reward campaign offer rules;

FIGS. 9-19B are example user interface screens; and;

FIG. 20 is a diagrammatic representation of machine in the example form of a computer system within which a set of instructions for causing the machine to perform any one or more of the methodologies discussed herein, may be executed.

### DETAILED DESCRIPTION

Example methods and systems to provide a multi-merchant rewards platform are described. The systems and methods providing a multi-merchant rewards platform, in some example embodiments may provide a merchant with the ability to create a rewards campaign within a multi-merchant network-based commerce system to drive sales of targeted products or services. In the following description, for purposes of explanation, numerous specific details are set forth in order to provide a thorough understanding of example embodiments. It will be evident, however, to one skilled in the art that the present invention may be practiced without these specific details. It will also be evident, that the multi-merchant rewards platform is not limited to the examples provided and may include other scenarios not specifically discussed.

In an example, a rewards program is a mechanism of rewarding loyalty by returning to individuals engaging in transactions with a particular business or group of businesses a kick-back based on some measurable aspect of the transactions. For example, an individual that makes multiple purchases over time with a certain business or group of businesses may receive a percentage of her overall spend back as a reward. In another example, a credit card company may provide users of a particular credit card a percentage kickback on all monetary transactions conducted by a particular user on the credit card. In the credit card example, the kickback (reward) may be a monetary credit to the users account. In another example, a particular retailer may offer a rewards program that gives the user credits to be applied to future purchases with that retailer (merchant). In some example, a reward is a non-monetary allocation of points that may be redeemed to discount a future purchase. In certain examples, the non-monetary allocation of points may be used to purchase select items within a product or service catalog or network-based publication system.

In an example, the multi-merchant rewards platform (also referred to as the global rewards platform, rewards platform, global rewards network, or rewards network) may include the ability for individual sellers (merchants) within a multi-merchant marketplace to fund rewards for the promotion of the seller's products or services. Sellers may target individual users within the multi-merchant marketplace with specific promotions ranging form a rewards percentage to a lump sum rewards to a rewards points multiplier. Individual users may be targeted based on any user metric tracked within the multi-merchant marketplace (or other network-based publication system), such as but not limited to the following parameters:
Browsing Activity
User Feedback Score
Payment History
Purchase History
Purchase History with a particular Merchant
Payment promptness (offer additional rewards for immediate payment)
User/Buyer Demographic information
Publishing a Guide
Publishing Reviews
Other Buyer Performance characteristics

In an example, a merchant can target rewards to new customers, repeat customers, or customers that have engaged in a certain volume of business with the merchant. Merchants can target rewards to certain categories of products or services, to specific products or services, or to individual users (as discussed above).

In certain examples, the multi-merchant reward platform can be used to encourage casual sellers (merchants) by rewarding the publication of listings within the multi-merchant marketplace. The rewards can be based on publications or actual sales volume (number of listings sold or monetary volume).

### DEFINITIONS

The following definitions are given by way of example and are not intended to be construed as limiting. A person of skill in the art may understand some of the terms defined below to include additional meaning when read in the context of this specification.

“PayPal”—PayPal provides a mechanism for enabling transfer of funds from one user to another user without revealing any financial identification, such as bank account numbers or credit cards. Paypal is an eBay, San Jose Calif., company and can be found at www.paypal.com.

“VI”—View Item. View Item generally refers to the displaying of an individual product or service offering within a network-based publication or marketplace system.

“Reward”—A reward within the specification generally refers to a non-monetary point allocation. In an example, rewards may be used within a network-based marketplace or network-based publication system to purchase goods and services. In another example, rewards may be used to discount the purchase of good and services. In a further example, rewards may be accumulated and once a certain threshold is crossed stored value coupons may be issued. Generally, rewards (non-monetary point allocations) have no value outside the rewards network. A reward may also be referred to as reward points.

“Rewards Network”—A rewards network generally refers to an associated group of businesses that except a certain form of non-monetary points (rewards) as at least a partial form of monetary payment for goods and services. In some examples, the rewards network members may provide discounts (e.g., 10%) in exchange for a certain number of non-monetary points (reward points).

“Offer”—(in terms of reward type) Base offer—An offer or base offer when discussed in terms of a rewards campaign generally represents the primary rule (or set of rules) governing incentives available within the rewards campaign (or cycle). Every campaign has a single base offer and once attached, is in effect for the duration of the campaign independent of any other bonuses that may also apply.

“Bonus”—A bonus when discussed in terms of a reward campaign generally represents a secondary rule (or set of rules) governing incentives offered in addition to the base offer within a rewards campaign.

“Program”—A program may encapsulate a collection of rules, segments, bonuses, global settings, etc. . . . into a single entity. In some examples, the network-based publication system may support only a single program. In other examples, the network-based publication system can support multiple programs.

“Campaign” (Cycle)—A program may consist of a collection of campaigns (or cycles) where each campaign typically represents a time span. In some examples, campaigns within a program are non-overlapping. In other examples, a program can contain any number of campaigns operating across various overlapping time periods. Campaigns typically contain attributes such as a base offer and a list of bonuses that occur within that campaign. Typically the end of a campaign represents a payout period for rewards accumulated in the campaign. In an example, a campaign can start with the quarter start date (00:00:00 hrs.) and ends with last day of the quarter (23:59:59 hrs.).

“Rule”—A rule includes a collection of conditions and actions that govern how rewards are distributed within the rewards platform. Rules can be represented using the logical expression: “if (conditions) then action”. Rules can be named and maintained in an inventory relative to a program or campaign. When combined with a start and end date in a cycle, a rule can define a bonus. The action of a rule represents a reward grant of some type.

“Condition”—Each rule may contain a collection of conditions which must all evaluate to true in order for the associated action to be performed. Conditions typically consist of a property, operator and value where the property is an attribute such as item category, price, or buyer (userID). Operators are specific to the property type but for numeric properties consists of arithmetic equality operators such as equals, greater than, less then, etc. . . . . The value consists of a user specified value or set of values to compare the property to.

“Global settings”—Global settings may include a collection of per-program settings that can be used to apply conditions above and beyond those specified in rules. For example, category restrictions may be defined at a global settings level that will then apply to all rules. At any given point, the rewards system maintains two distinct copies of the global settings. One for the current cycle and the other one for “all” the future cycles. Global settings associated with previous cycles can be different from these two copies.

“Custom User Segments”—A segment is typically a named collection of uploaded user lists. Using conditions it is possible to have a rule only perform an action if a user (based on userID) is in or not in a particular segment.

### Platform Architecture

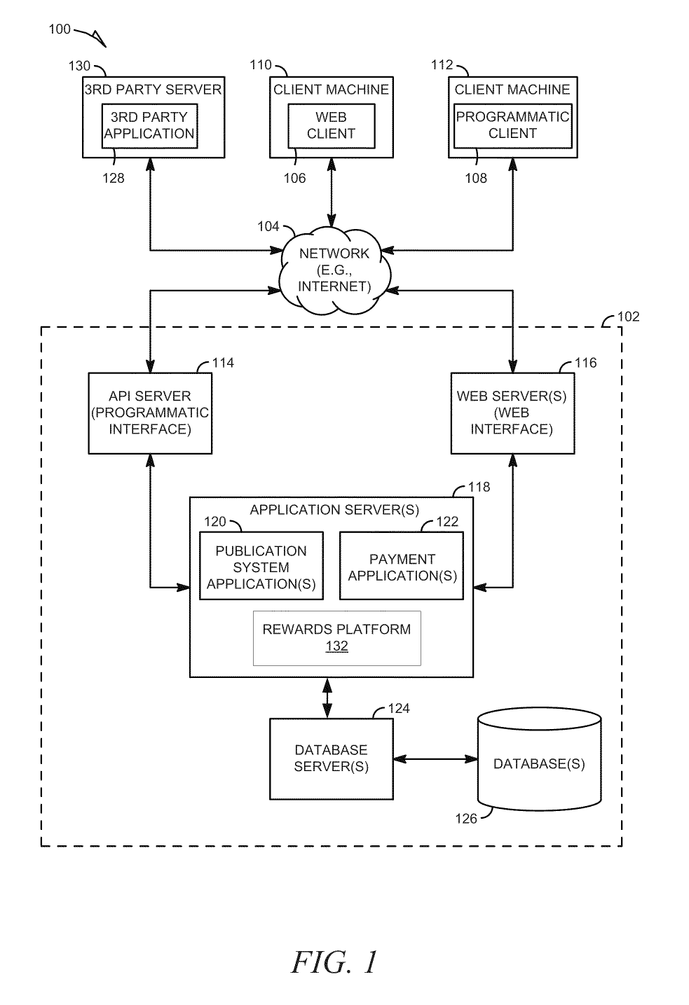

FIG. 1 is a block diagram illustrating an example architecture for a network-based marketplace within which methods and systems to provide a multi-merchant rewards platform can be implemented. The block diagram depicting a client-server system 100, within which an example embodiment can be deployed. A network-based system 102, in the example forms of a network-based marketplace or publication system, provides server-side functionality, via a network 104 (e.g., the Internet or Wide Area Network (WAN)) to one or more client machines 110, 112 respectively including client components. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more publication system applications 120, payment applications 122, and reward platform 132. The application servers 118 are, in turn, shown to be coupled to one or more databases servers 124 that facilitate access to one or more databases 126. In some examples, the application server 118 can access the databases 126 directly without the need for a database server 124.

The publication system applications 120 may provide a number of marketplace functions and services to users that access the network-based system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the publication system applications 120. The payment application 122 may also be configured to allow for the redemption of loyalty points issued by one of the publication system applications 120. While the marketplace 120 and payment 122 are shown in FIG. 1 to all form part of the network-based system 102, it will be appreciated that, in alternative embodiments, the payment applications 122 may form part of a payment service that is separate and distinct from the network-based system 102.

Further, while the system 100 shown in FIG. 1 employs a client-server architecture, the present invention is of course not limited to such an architecture, and could equally well find application in a distributed, or peer-to-peer, architecture system, for example. The various marketplace 120 and payment 122 could also be implemented as standalone software programs, which do not necessarily have networking capabilities.

The web client 106 accesses the various publication system applications 120, payment applications 122 and reward platform 132 via the web interface supported by the web server 116. Similarly, the programmatic client 108 accesses the various services and functions provided by the publication applications 120, payment applications 122 and rewards platform 132 via the programmatic interface provided by the API server 114. The programmatic client 108 may, for example, be a seller application (e.g., the TurboLister application developed by eBay Inc., of San Jose, Calif.) to enable sellers to author and manage listings on the network-based system 102 in an off-line manner, and to perform batch-mode communications between the programmatic client 108 and the network-based system 102. Programmatic clients 108 can also be provided that enable sellers to author and manage coupons and coupon campaigns on the network-based system 102 in either an on-line or off-line mode.

FIG. 1 also illustrates a third party application 128, executing on a third party server machine 130, as having programmatic access to the network-based system 102 via the programmatic interface provided by the API server 114. For example, the third party application 128 may, utilizing information retrieved from the network-based system 102, support one or more features or functions on a website hosted by the third party. The third party website may, for example, provide one or more promotional, marketplace or payment functions that are supported by the relevant applications of the network-based system 102. Additionally, the third party website may provide a user access to view rewards issued by the network-based system 102 through the reward platform 132.

### Publication System Applications

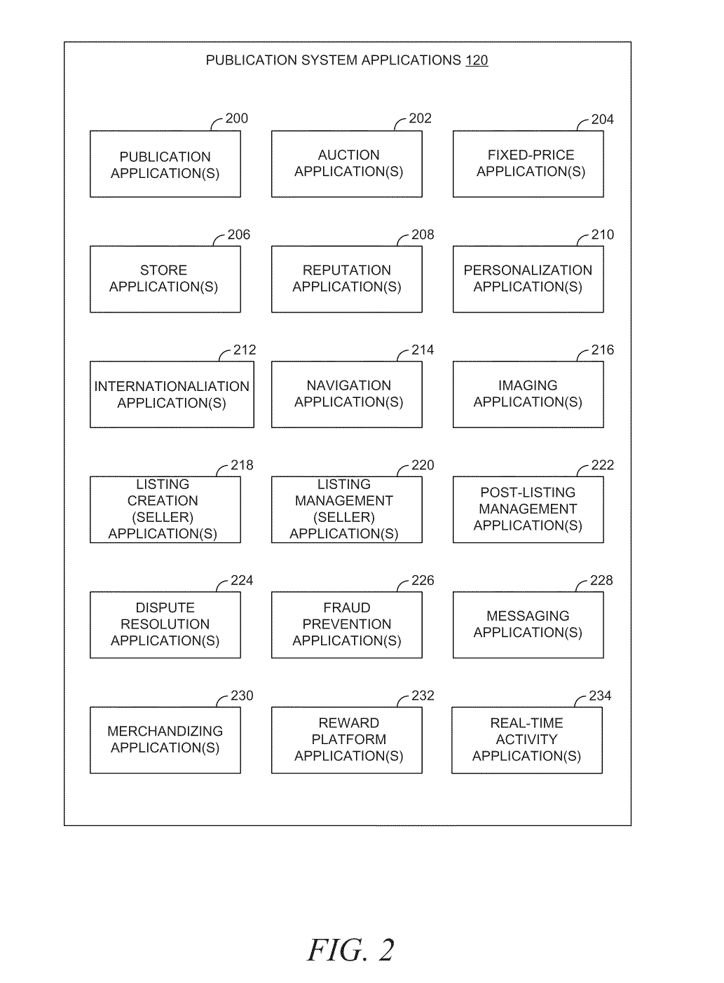

FIG. 2 is a block diagram illustrating multiple publication and system applications that, in one example embodiment, provided as part of the network-based marketplace some of which can be used to provide a multi-merchant rewards platform, among other things. The publication and system applications 120 may be hosted on dedicated or shared server machines (not shown) that are communicatively coupled to enable communications between server machines. The publication and system applications 120 themselves are communicatively coupled (e.g., via appropriate interfaces) to each other and to various data sources, so as to allow information to be passed between the publication and system applications 120 or so as to allow the applications to share and access common data. The publication and system applications 120 may furthermore access one or more databases 126 via the database servers 128.

The network-based system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the network-based system 102, to establish, build and maintain reputations, which may be made available and published to potential trading partners. Consider that where, for example, the network-based system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the network-based system 102 over time. Other potential trading partners may then reference such a reputation for the purposes of assessing credibility and trustworthiness.

Personalization applications 210 allow users of the network-based system 102 to personalize various aspects of their interactions with the network-based system 102. For example a user may, utilizing an appropriate personalization application 210, create a personalized reference page at which information regarding transactions to which the user is (or has been) a party may be viewed. A personalized reference page can be configured to display all rewards issued to the user by one of the reward platform 132. Further, a personalization application 210 may enable a user to personalize listings and other aspects of their interactions with the network-based system 102 and other parties. Additionally, a personalization application can enable a user to view and organize coupons issued by the marketplace or individual merchants within the marketplace.

The network-based system 102 may support a number of marketplaces that are customized, for example, for specific geographic regions. A version of the network-based system 102 may be customized for the United Kingdom, whereas another version of the network-based system 102 may be customized for the United States. Each of these versions may operate as an independent marketplace, or may be customized (or internationalized) presentations of a common underlying marketplace. The network-based system 102 may accordingly include a number of internationalization applications 212 that customize information (and/or the presentation of information) by the network-based system 102 according to predetermined criteria (e.g., geographic, demographic or marketplace criteria). For example, the internationalization applications 212 may be used to support the customization of information for a number of regional websites that are operated by the network-based system 102 and that are accessible via respective web servers 116.

Navigation of the network-based system 102 may be facilitated by one or more navigation applications 214. For example, a search application (as an example of a navigation application) may enable key word searches of listings published via the network-based system 102. A browse application may allow users to browse various category, catalogue, or inventory data structures according to which listings may be classified within the network-based system 102. Various other navigation applications may be provided to supplement the search and browsing applications. Certain navigation applications may be configured to surface coupons relevant to the search or browsing pages delivered in response to a user's query.

In order to make listings, available via the network-based system 102, as visually informing and attractive as possible, the publication system applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the network-based system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the network-based system 102.

Messaging applications 228 are responsible for the generation and delivery of messages to users of the network-based system 102, such messages for example advising users regarding the status of listings at the network-based system 102 (e.g., providing “outbid” notices to bidders during an auction process or to provide promotional and merchandising information to users). The messaging applications 228 can also be used to deliver non-monetary point allocations or coupons generated by the rewards platform 132 to users on the network-based system 102. Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks. The messaging applications 228 may also be configured to communicate over certain social networking platforms, such as Twitter or Facebook (developed by Facebook, Inc. of Palo Alto, Calif.). Communication with a social networking platform may require installation of a application or plug-in within a user's social network account.

Merchandising applications 230 support various merchandising functions that are made available to sellers to enable sellers to increase sales via the network-based system 102. The merchandising applications 80 also operate the various merchandising features that may be invoked by sellers, and may monitor and track the success of merchandising strategies employed by sellers.

The network-based system 102 itself, or one or more parties that transact via the network-based system 102, may operate reward programs that are supported by one or more reward platform applications 232. For example, a buyer may earn loyalty or rewards points (non-monetary point allocations) for each transaction established and/or concluded with a particular seller, and be offered a reward for which accumulated rewards points can be redeemed. The rewards platform applications 232 may work in conjunction with the coupon applications (not shown) to reward loyal users with valuable coupons for use within the network-based marketplace 102. In some examples, the reward platform applications 232 include functionality discussed in various other portions of this document. In certain examples, the reward platform applications 232 may execute within the rewards platform 132.

Real-time activity applications 234 support various functions within the network-based system 102 by providing real-time information about user activities within the network-based system 102. For example, the real-time activity applications 234 can provide information to the messaging applications 228 or personalization applications 210 to enhance a user's experience or improve a seller's ability to move merchandise. In certain examples, the real-time activity applications 234 provide real-time activity data to the reward platform applications 232 enabling real-time, instantaneous delivery of user targeted rewards (e.g., non-monetary point allocations).

### Example Rewards Platform Architecture

In accordance with an example embodiment, a system can provide all merchants registered within an online marketplace access to a platform to reward buyers with financial incentives for purchases and other relevant activities performed in association with each individual merchant.

The global rewards platform can include the following elements
Rewards engine and related interfaces to calculate reward earning and update/track individual user balances
Marketing administration console/tool to enable creation and management of reward campaign offers and promotional campaigns
Onsite integration with various display or publication mechanisms, such as a view item page, global page header, or a user's account summary page.
Integration with customer support tools to enable key customer support functionality.
Integration with a reward redemption engine, such as may be provided by a third-party financial transaction partner (e.g., PayPal).

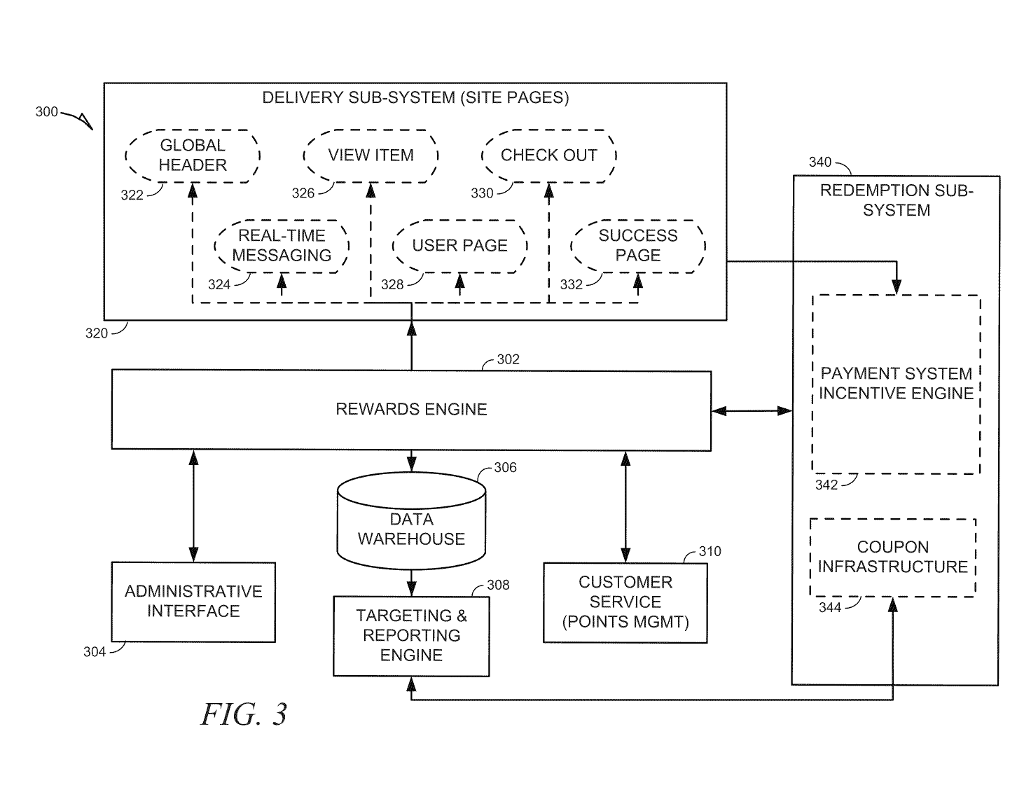

FIG. 3 is a block diagram illustrating an example system 300 to provide a multi-merchant rewards platform. The system 300 includes a reward engine 302, an administrative interface 304, a data warehouse 306, a targeting and reporting engine 308, a customer service module 310, a delivery sub-system 320, and a redemption sub-system 340. In certain examples, the delivery sub-system 320 includes display modules such as: a global header module 322, a real-time messaging module 324, a view item module 326, a user page module 328, a check out module 330, and a success page module 332. In an example, the delivery sub-system 320 can use user-interface widgets or controls in place of the display modules described above to display rewards information. In some examples, the redemption sub-system 340 includes a payment system incentive engine 342 and a coupon infrastructure 344. The payment system incentive engine 342 can provide integration with an online payment system such as PayPal.

In an example, the rewards engine 302 may be used to implement a rewards program defined by a merchant. The rewards engine 302 can identify users that match user qualifiers defined within the reward program. The rewards engine 302 can also track real-time user activity in order to apply available rewards points to eligible user actions. In some examples, the reward engine 302 receives real-time user activity data from the real-time activity applications 234. The rewards engine 302 can also interface with the delivery sub-system 320 to display available rewards to a user browsing with the network-based system 102. The rewards engine 302 also interfaces with the redemption sub-system to enable users to redeem reward points accumulated through various transactions within the network-based system 102.

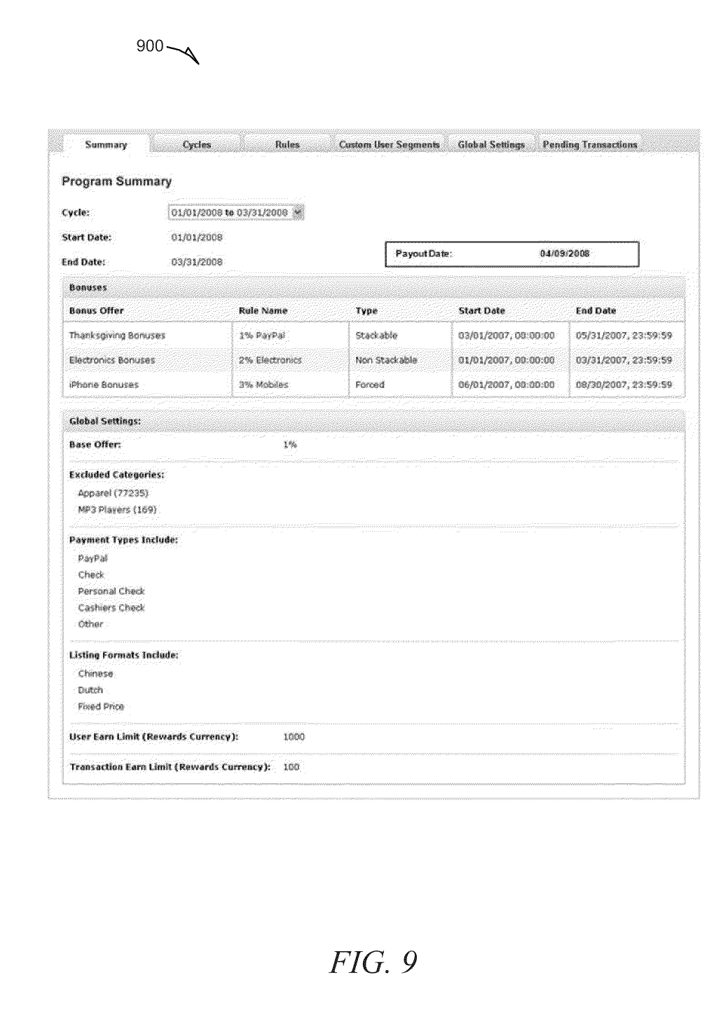

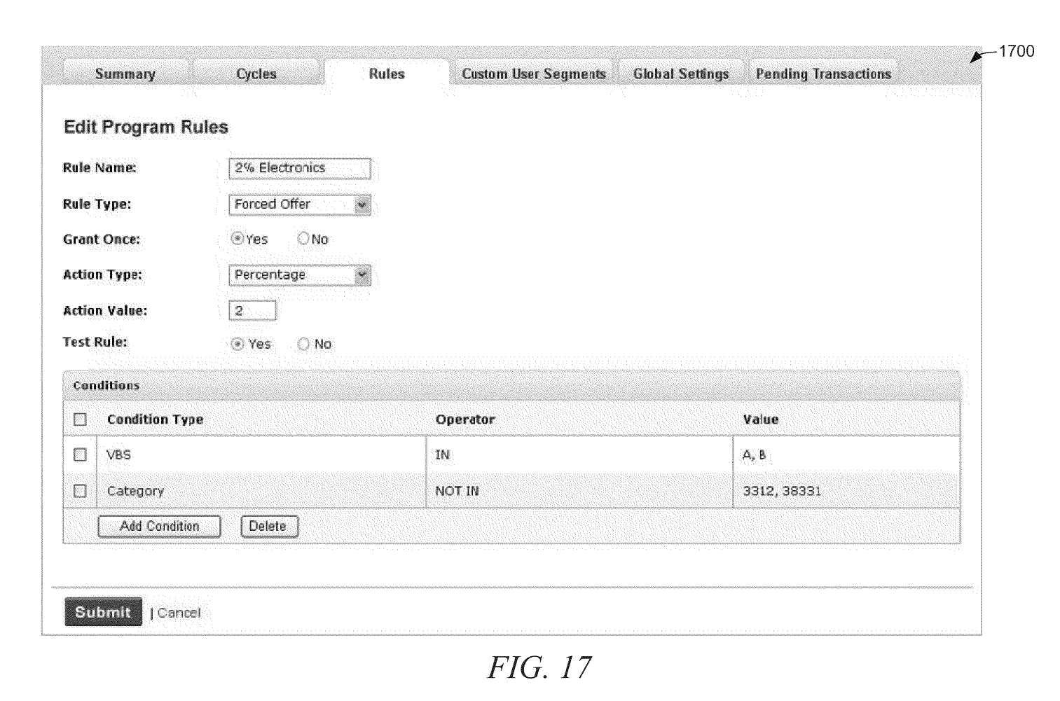

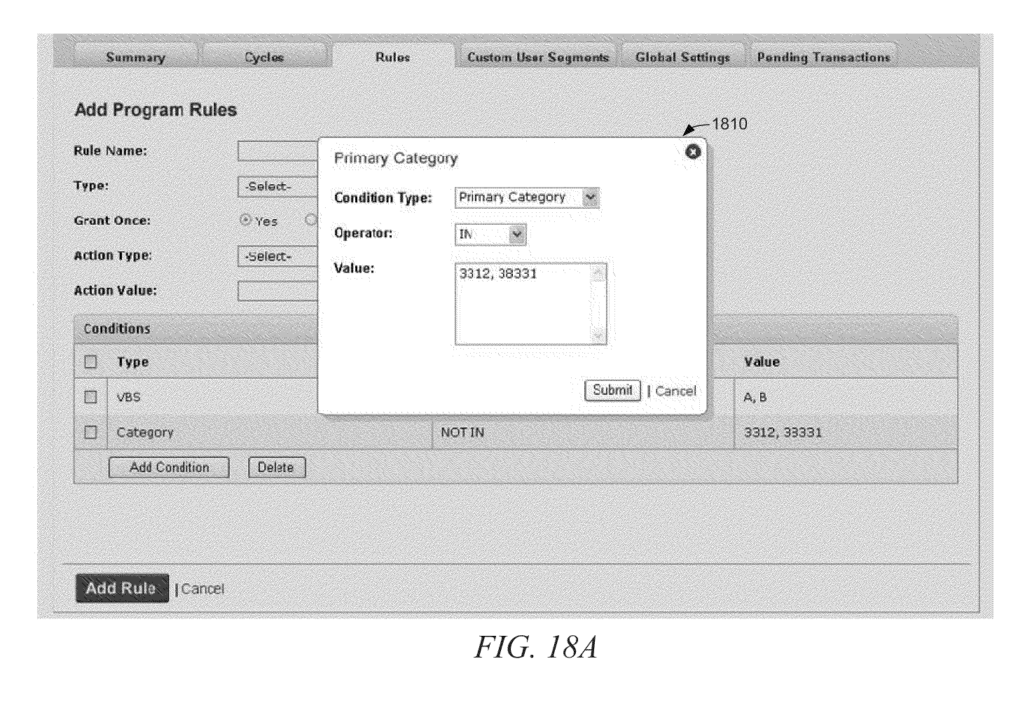

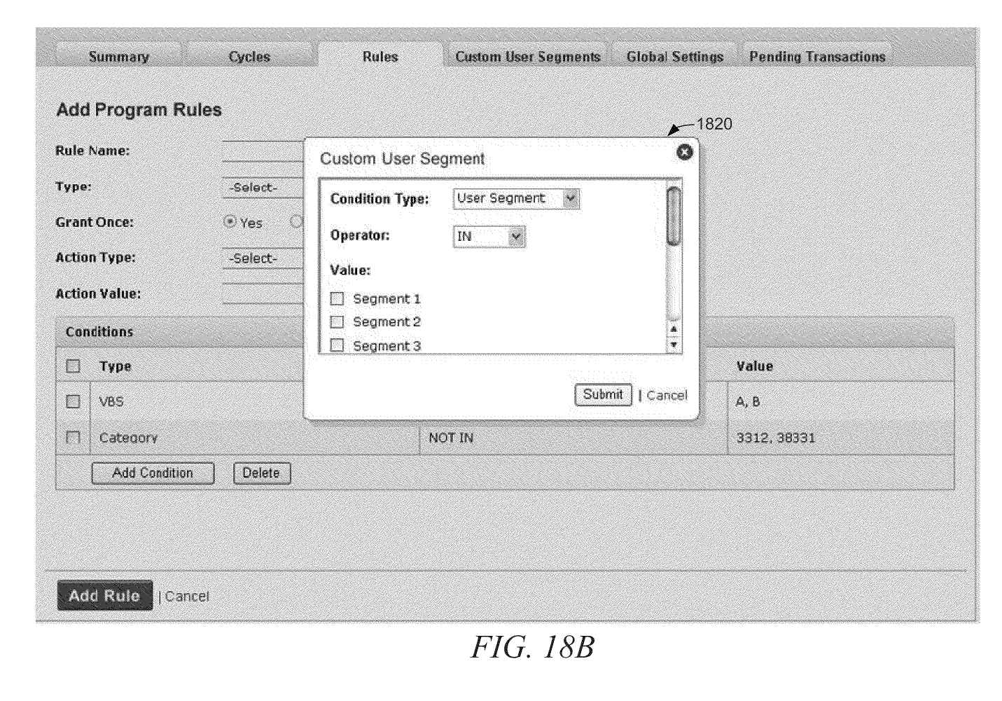

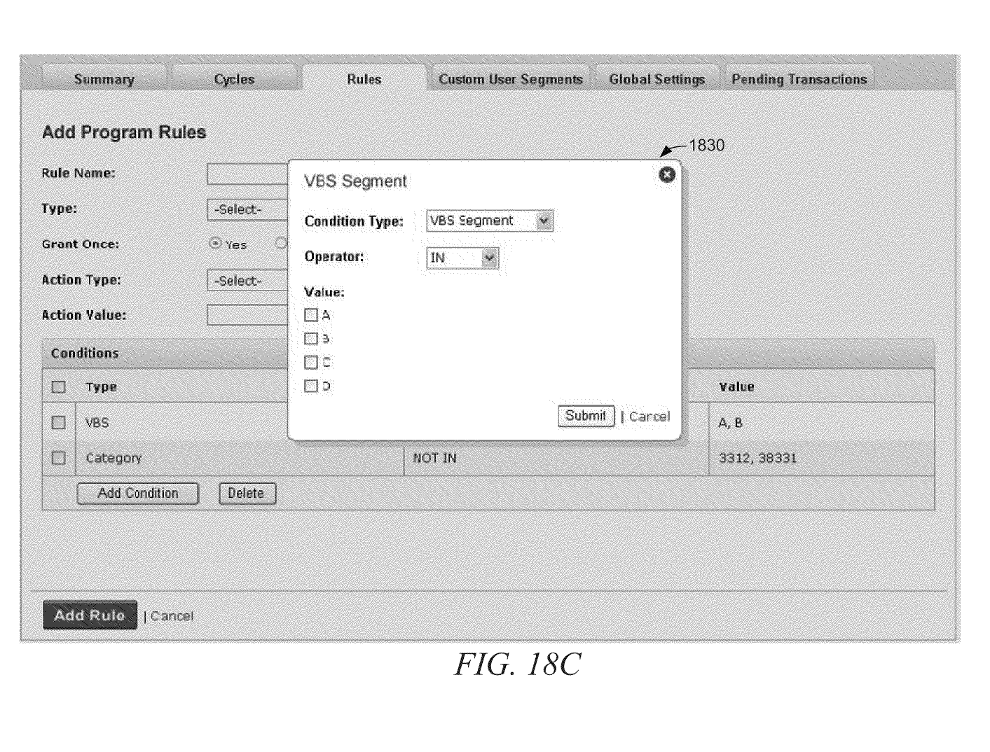

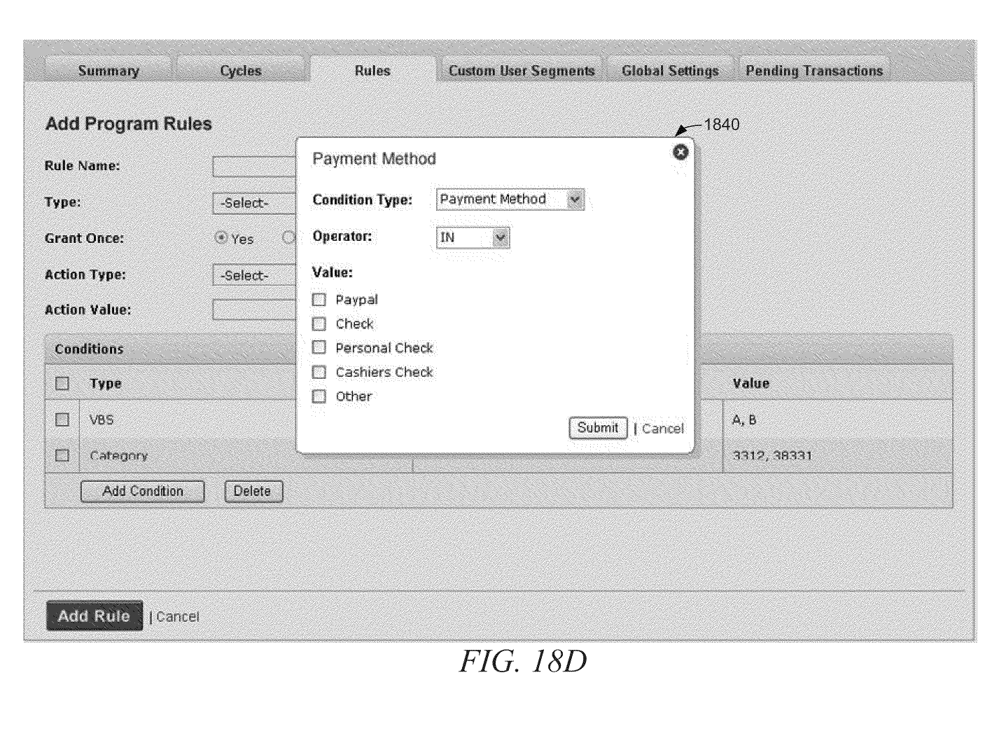

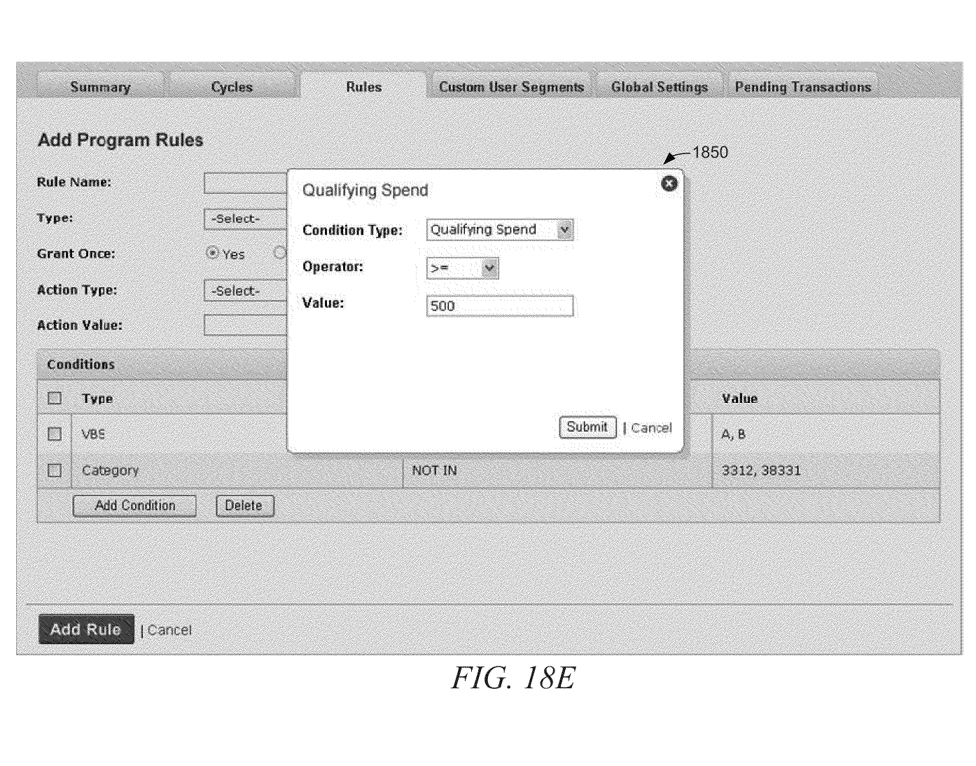

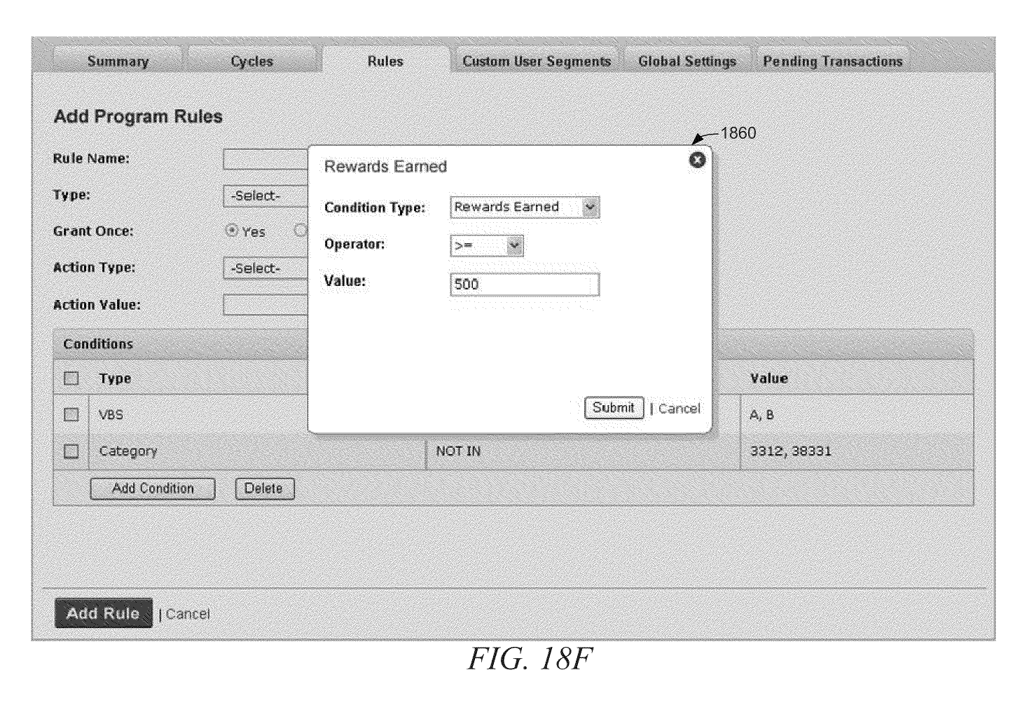

In an example, the administrative interface 304 can provide a merchant with a user interface to configure a rewards program. A rewards program can be used by a merchant to define the means by which rewards are used to promote the merchant's products or services within the network-based system 102. In some examples, the rewards program contains one or more campaign rules that can be used by the rewards engine 302 to identify eligible users and eligible user activities. A series of example user interface screens produced by the administrative interface 304 are discussed below in reference to FIG. 9-18F.

The data warehouse 306 can receive data from the rewards engine 302 related to rewards programs and user activities within the network-based system 102. In an example, the data warehouse 306 can produce daily reports from the data collected from the rewards engine 302. The data warehouse 306 can also perform automated daily validation of data received from the rewards engine 302 as well as data received from the network-based system 102. In some examples, the daily validation performed by the data warehouse 306 is done on an incremental basis. In certain examples, the data warehouse 306 in conjunction with the rewards engine 302 can trigger e-mail communications or other communications via the delivery sub-system 320 to notify users of special reward earning opportunities.

In an example, the targeting and reporting engine 308 uses the data stored in the data warehouse 306 to target user actions and provide reports on rewards program activity.

In an example, the customer service module 310 provides customer service personnel with an interface into the rewards engine 302. The customer service module 310 can enable customer service to manage reward programs, reward points allocations, and reward redemption issues.

The delivery sub-system 320 can be used to display information related to the rewards platform. In certain examples, the delivery sub-system 320 works in conjunction with the web server 116 to present information generated by the rewards engine 302 to users over a network 104. In some examples, the delivery sub-system 320 also works in conjunction with the API server 114 to present programmatic information generated by the rewards engine 302.

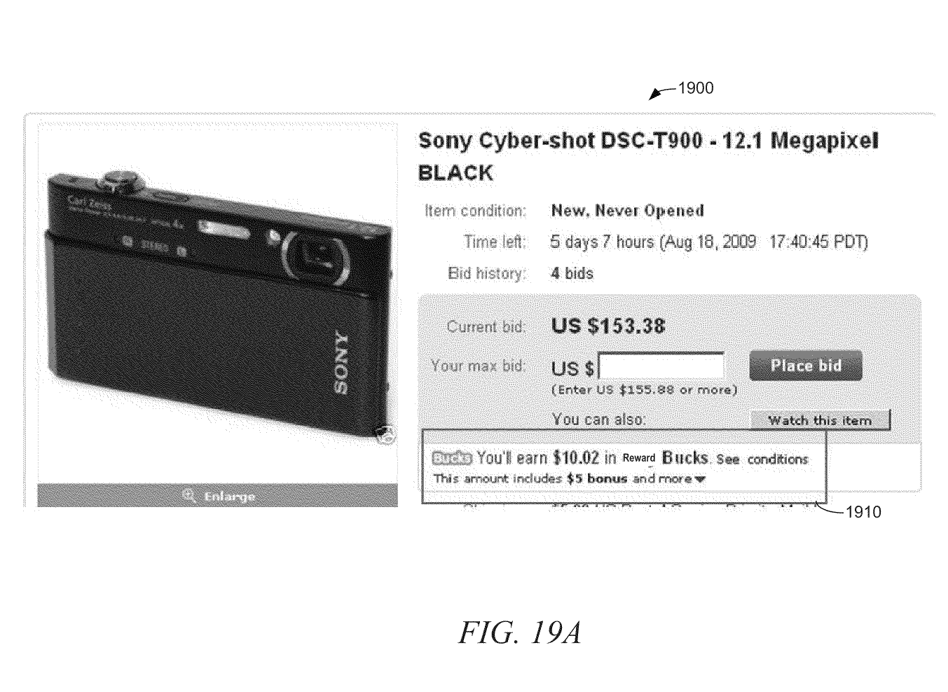

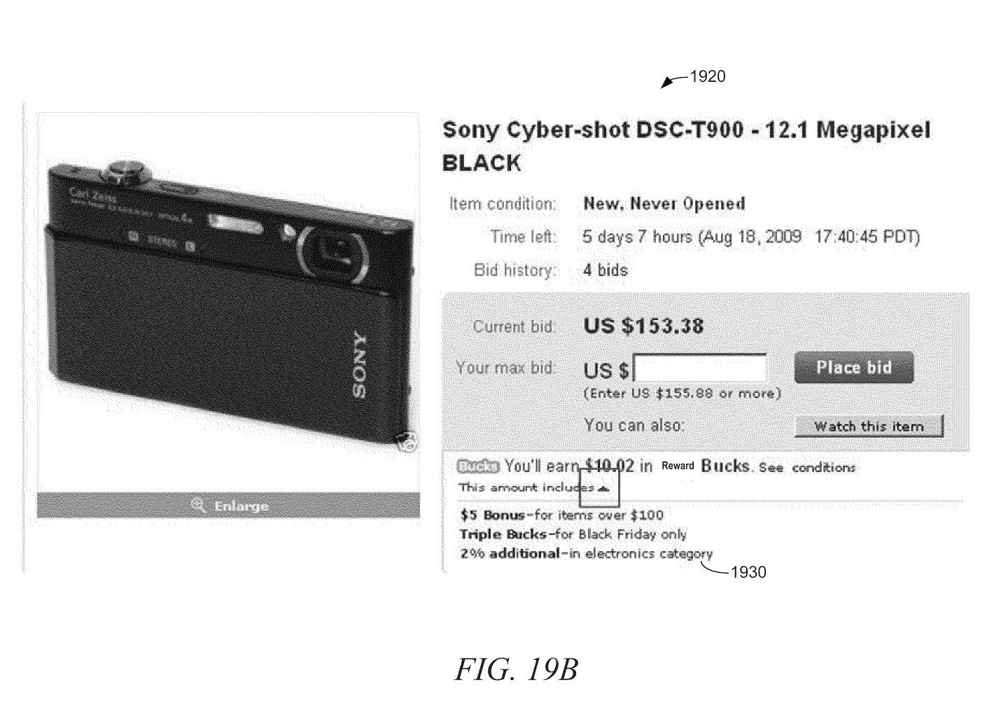

As mentioned above, the delivery sub-system can include display modules such as: a global header module 322, a real-time messaging module 324, a view item module 326, a user page module 328, a check out module 330, and a success page module 332. The global header module 322 can display information generated by the rewards engine 302 within the header portion of web pages generated by the web server 116. The real-time messaging module 324 can display information generated by the rewards engine 302 within pop-up message windows, banners, or other user-interface artifacts generated by the web server 116. The view item module 326 can display information generated by the rewards engine within item information pages, such as those illustrated in FIG. 19A-B. The user page module 328 can display information generated by the rewards engine 302 within user account summary and detail pages. The check out module 330 can display information generated by the rewards engine 302 within virtual shopping cart pages. The success page module 332 can display information generated by the rewards engine 302 within pages generated as the result to a successful operation, such a purchase or payment action.

In certain examples, the redemption sub-system 340 includes a coupon infrastructure 344 configured to allow redemption of stored value credit coupons generated by the rewards engine 302. In this example, rewards points are periodically converted by the rewards engine 302 (or in some examples, by the redemption sub-system 340) into stored value credit coupons that can be redeemed within the network-based system 102. In certain examples, the stored value credit coupons include an expiration date. In an example, the rewards engine 302 is configured with defined earn periods during which users can accumulate rewards points within a user account. At the end of each earn period the system can convert a users accumulated points into stored value coupons that the user can redeem towards the purchase of goods or services from merchants within the rewards network.

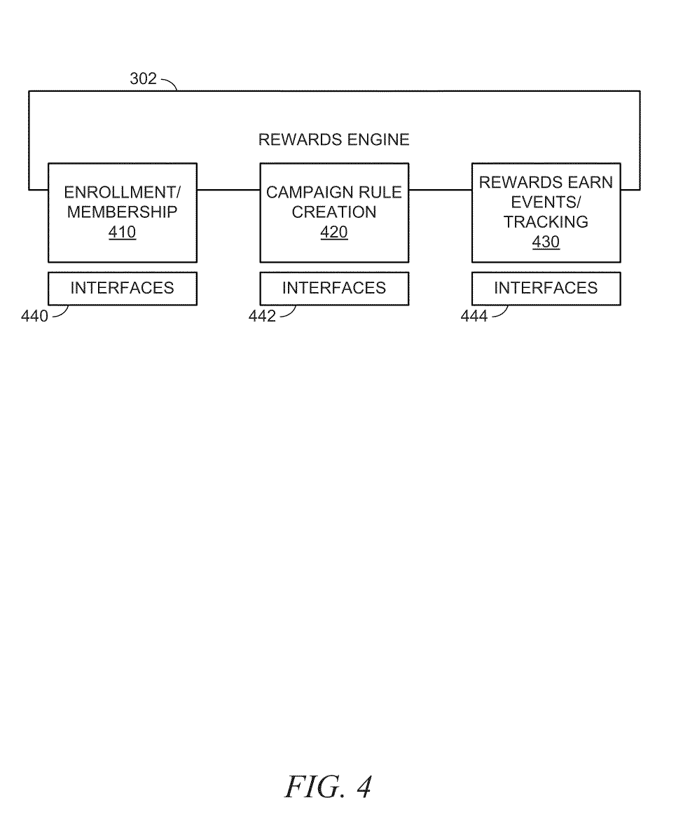

FIG. 4 is a block diagram illustrating an example rewards engine 302 component of a multi-merchant rewards platform. In this example, the rewards engine 302 includes an enrollment and membership component 410, a campaign rule creation component 420, and a rewards earn events and tracking component 430. In this example, interfaces 440, 442, 444 provide various methods of interacting with the respective component. The interfaces support programmatic interface through protocols such as, HTML (Hyper Text Markup Language), XML (eXtensible Markup Language), RPC (Remote Procedure Call), and COM/DCOM (Component Object Messaging/Distributed COM), among others

The enrollment and membership component 410 can provide for member (user) enrollment into a rewards program. In some examples, a user can use the enrollment and membership component 410 to enroll as a user within the rewards platform and thus can be automatically enrolled into all rewards programs that may be run within the platform. In an example, a user is represented within the network-based system 102 as a unique userID. It is the unique userID that the enrollment and membership component 410 uses to enroll the user. In certain examples, the rewards engine 302 can require enrollment for each rewards program run within the rewards platform. In some examples, merchants sponsoring a rewards campaign can require enrollment within specific campaigns.

In some examples, the rewards engine 302 and the enrollment and membership component 410 support multiple membership types, such as basic and premium. A premium level membership may require an annual fee and may provide the user access to a higher level of rewards earning potential and/or access to other special rewards benefits. Both the reward engine 302 and the enrollment and membership component 410 support the creation of additional membership types. In certain examples, individual merchants can create membership types as part of a unique rewards program or campaign.

In certain examples, the enrollment and membership component 410 supports white lists and black lists to enable and disable enrollment within a rewards program. White lists can be used to designate a list of users (userIDs) eligible for enrollment into a rewards program. Black lists can be used to designate a list of users (userIDs) that are ineligible for enrollment into a rewards program. Both white lists and black lists can be created using query logic against a registered user database. For examples, a white list can include all users registered with addresses within the continental United States. The enrollment and membership component 410 can also support custom user segments that function like multiple white/black lists.

In an example, the enrollment and membership component 410 can be configured to request things like email settings during user enrollment. The email settings can include notification preferences such as earn balance updates, bonus promotion announcements, or special offers. Some notifications may be required for participation in a rewards program, for example program changes to terms and conditions of enrollment, reward redemption code available notices, end of earn period notices, and end of redemption period notices.

In an example, the campaign rule creation module 420 can be used to create reward campaign or reward program rules. Reward program rules can include incentive type (offer or bonus), event type, user qualifier, item qualifier, and a time qualifier, among other things. In some examples, offers are referred to as an allocation (e.g. an allocation of reward points). Bonus incentive types can be a multiplier (e.g., multiplying a standard point allocation), an additive percentage (e.g., add 1% extra to the base offer %), or an additive lump sum. In certain examples, the bonus incentive type can also be a forced bonus that applies after the optimal rewards calculation is completed using the other available offers and bonuses (stackable or non-stackable). Forced bonuses can be applied regardless of whether a non-stackable bonus was used in the optimal calculation. Table 1 includes some basic definitions of campaign rules for an example embodiment.

TABLE 1
Campaign Rules Overview

| | Definition | Example |
|---|---|---|
| Rule Name | | |
| Reward campaign | Base program offering: | 2% earn spend on item |
| Offer Rule | Reward calculation applied | amounts for all eligible |
| | to broad base of users; only | purchases |
| | 1 offer per user can be | |
| | applied | |
| Reward campaign | Promotional reward | Double earn for eligible |
| Bonus Rule | calculation applied to | purchases in jewelry |
| | specific or all users; can be | and watches. |
| | stacked or combined with | |
| | the user's offer and other | |
| | bonuses | |
| Component Name | | |
| Rule Type | Reward calculation built | OFFER or BONUS |
| | with a number of | |
| | components; type can be | |
| | offer or bonus | |
| Event Type | Event that triggers reward | Purchase and payment |
| | earn calculation | |
| User Qualifier | Defines the Users eligible | All users, VBS = A + B |
| | for the Rule; for phase 1 we | segment, specific user |
| | will confine user qualifiers | uploaded list, etc |
| | to just Bonuses | |
| Item Qualifier | Defines the items eligible | Only items in Shoes |
| | for the Rule | category that are paid |
| | | for via PayPal |
| Time qualifier | Defines the | From Apr. 1, 2009 to |
| | start/end/excluded time for | Jun. 30, 2009, no |
| | Rule | blackout/exclusion |
| | | dates |
| TBD - extensible | The rewards engine 302 is | N/A |
| component | configured to accept new | |
| | rule components | |
| Offer Calc | Key numeric input of Earn | 2% of final item price |
| | calculation for Offer Rule | |
| | only (only applies to Offer | |
| | Rules) | |
| Bonus Calc | Key numeric input of earn | Double (2x) the offer |
| | calculation for Bonus Rule | %, $5, additional 1% |
| | only (only applies to Bonus | |
| | Rules) | |

The campaign rule components introduced in Table 1 provide capabilities including targeting all users with an offer and targeting a segment of users with a bonus. Additionally, users (userIDs) can be included in multiple lists (e.g., receive multiple offers and bonuses). Campaign rules can include dynamically changing lists of users (userIDs) used to target offers and/or bonuses.

An additional aspect of defining a rewards program or campaign includes defining an earn period and a burn period. During an earn period users can accumulate reward points that can be used against purchases during a burn period. A default earn and burn period may be defined within the rewards program. For example, by default the system will allow for a 3 month earn period followed by a 3 month burn period. In some examples, the default burn period may be limited to 1 month in order to incent a quicker turn around in using rewards for future purchases.

Table 2 provides three example Offer and Bonus calculation examples that illustrate the concept of stackable and non-stackable bonuses. If a bonus is stackable it can be used in conjunction with other bonuses. If a bonus is not stackable, the bonus cannot be used in conjunction with another bonus.

TABLE 2
Offer and Bonus Example Scenarios

| | User 1 | User 2 | User 3 |
|---|---|---|---|
| OFFER AND | All stackable | Non stackable | 2 multiplier |
| BONUS TYPE | bonuses | bonuses | bonuses |
| BASE | 2% | 2% | 2% |
| PROGRAM | | | |
| OFFER | | | |
| Bonus 1 | Multiplier: Double | Multiplier: Double | Multiplier: Double |
| | points for CSA | points for CSA | points for CSA |
| | category | category | category |
| | [Stack = yes] | [Stackable = NO] | [Stack = yes] |
| Bonus 2 | Additive: 1% for | Additive: 1% for | Multiplier: Double |
| | promo week | promo week | points for reaching |
| | [Stack = yes] | [Stack = NO] | $200 |
| | | | [Stack = yes] |
| Bonus 3 | Lump sum: $5 | Lump sum: $5 | Lump sum $5 when |
| | when reaching | when reaching | reaching $200 |
| | $200 spend | $200 spend | spend threshold |
| | threshold | threshold | [stack = No] |
| | [Stack = yes] | [Stack = NO] | |
| Event | User buys eligible | User buys eligible | User buys eligible |
| | $200 item in CSA | $200 item in CSA | $200 item in CSA |
| Final calculation | Mult = Offer 2% × 2 = | Optimal bonus is $5 | Mult = Offer 2% × 2 = |
| | 4% + 1% = 5% | | 4% + 2% × 2 = 8% |
| | $200 × 5% = $10 | | |
| | additive bonus = $5 | | |
| | Total earn: $15 | Total earn: $9 | Total earn: $16 |
| | offer = $4 | offer = $4 | offer = $4 |
| | total bonus = $11 | bonuses = $5 | bonuses = $12 |
| Notes: | All bonuses apply | Only 1 bonus can | Lump sum does not |
| | since they are all | apply in addition to | apply since it is not |
| | stackable | offer be they are all | stackable is not |
| | | non stackable | optimal bonus |

In an example, the rewards earn events and tracking component 430 provides capabilities for tracking earn events and subsequent reward point allocations. In some examples, reward earn events can be held in a pending state to prevent users from manipulating the rewards platform. For example, without the tracking provided by the reward earn events and tracking component 430 it may be possible for a user to purchase an item, receive the rewards point allocation associated with the purchase, and then return the purchase. In some examples, the rewards earn events and tracking component 430 provides individual merchants with the ability to transition reward point allocations from a pending state to an approved (or completed) state after a period of time. For example, if a merchant has a 90 days return period, the merchant could keep rewards point allocations pending until the return period expires. In certain examples, the rewards earn events and tracking component 430 can also enable merchants to retract approved rewards point allocations in the event of a invalidating action by the user, such as a return. In some examples, the rewards earn events and tracking component 430 can be accessed by customer service representatives (e.g., via the customer service module 310) to provide reward grants for item disputes or other customer service related issues. In certain examples, the rewards earn events and tracking component 430 can be accessed by third party vendors or partners to provide special rewards grants related to special promotions or product/service adoption.

### Example Methods

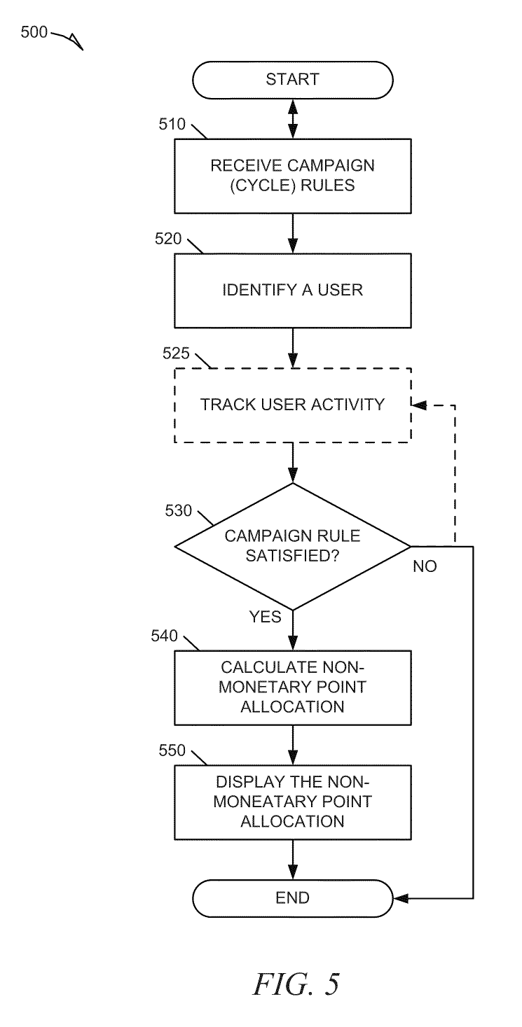

FIG. 5 is a flowchart illustrating an example method 500 for providing a non-monetary point allocation associated with a particular merchant to a user. In this example, the method 500 includes operations for receiving campaign rules at 510, identifying a user at 520, optionally tracking user activity at 525, determining whether a campaign rule has been satisfied at 530, calculating a non-monetary point allocation at 540, and displaying the non-monetary point allocation at 550.

In an example, the method 500 begins at 510 with the rewards engine 302 receiving campaign rules defining a merchant sponsored rewards campaign. In some examples, the campaign rules can be created within the administrative interface 304, which communicates with the rewards engine 302. In certain examples, the campaign rules can be stored in the data warehouse 306 with the rewards engine 302 accessing the rules as necessary from the data warehouse 306.

At 520, the method 500 can continue with the rewards engine 302 identifying a user accessing the network-based system 102. In this example, users are identified according to userID and password credentials provided during a log-in process. One of skill in the art will recognize that other more or less secure methods of user identification can be employed without materially changing the functionality discussed within this specification. Optionally, at 525 the method 500 can continue with the rewards engine 302 tracking user activities within the network-based system 102. In certain examples, the reward engine 302 can receive user tracking information from one of the real-time activity applications 234. The user activity information can be used by the rewards engine 302 to determine if any of the active campaign rules are satisfied by a user's activity. For example, a campaign rule may associate a reward point allocation with a user selecting an item for purchase. In some examples, the campaign rule may also require that the user checkout and pay for the item prior to reward point allocation. Any activity within the network-based system 102 that can be tracked can also be used as a qualifier within a campaign rule.

The method 500 continues at 530 with the rewards engine 302 determining if a campaign rule has been satisfied. In some examples, operation 530 can be satisfied when the rewards engine 302 detects a user action (event) that satisfies a campaign rule that is going to be displayed to the user. At 540, the method 500 continues with the reward engine 302 calculating a non-monetary (reward) point allocation. The non-monetary point allocation can include a base offer and one or more bonuses. In an example, each reward campaign will include a single base offer, such as 2% back on all purchases within an earn period. Merchants can also provide additional targeted incentives by using bonus offers, which can increase the overall rewards point allocation for a particular event.

At 550 the method 500 concludes with the delivery sub-system 320 displaying the non-monetary point allocation within one of the available user interface controls (322, 324, 326, 328, 330, 332). In some examples, the delivery sub-system 320 can display the non-monetary point allocation in proximity to the event (user action) that will result in the user receiving the non-monetary point allocation. For example, FIG. 19A illustrates an example view item user interface screen 1900 that includes a non-monetary point allocation 1910. FIG. 19B illustrates another example view item user interface screen 1920 that includes additional detail regarding a non-monetary point allocation 1930 available associated with this item. The view item user interface screens 1900, 1920 can be generated by the view item module 326.

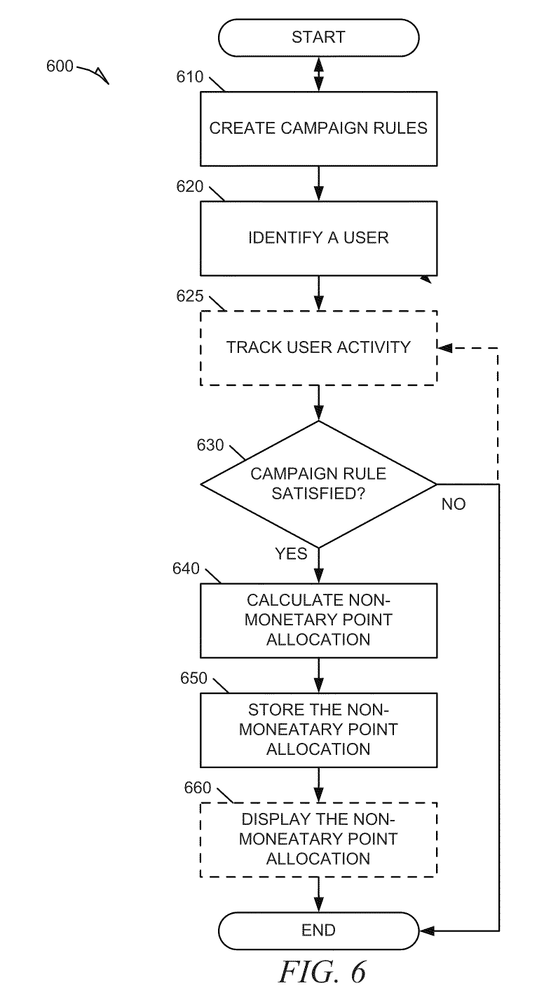

FIG. 6 is a flowchart illustrating an example method 600 for rewarding a user with a non-monetary point allocation associated with a particular merchant. In this example, the method 600 includes operations for creating campaign rules at 610, identifying a user at 620, optionally tracking user activity at 625, determining whether a campaign rule is satisfied at 630, calculating a non-monetary point allocation at 640, storing the non-monetary point allocation at 650, and optionally displaying the non-monetary point allocation at 660.

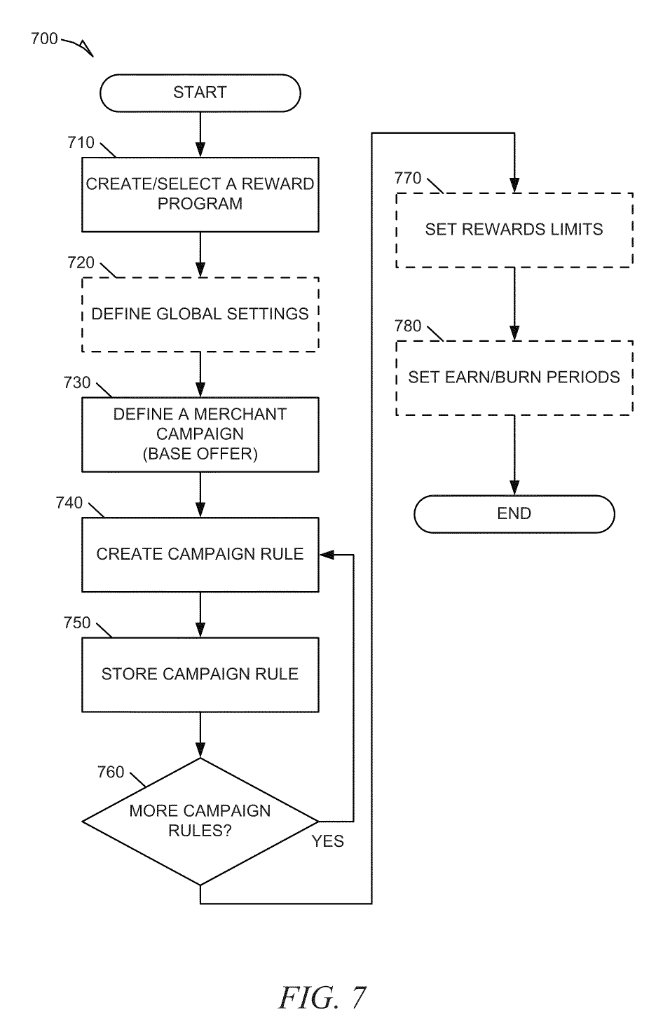

In an example, the method 600 begins at 610 with a merchant using the campaign rule creation component 420 to create campaign rules. In certain examples, a merchant can use the administrative interface 304 to create campaign rules. Further discussion regarding the creation of campaign rules is provide below in reference to FIG. 7.

At 620 the method 600 continues with the reward engine 302 identifying a user. In some examples, the enrollment and membership component 410 can be used to assist in user identification. The method 600 can optionally continue at 625 with the rewards engine 302 tracking user activity. At 630 the method 600 continues with the rewards engine 302 determining whether a user has satisfied a campaign rule. In some examples, the user activity tracked by the rewards engine 302 can trigger satisfaction of a campaign rule at 630.

The method 600 continues at 640 if a campaign rule is satisfied. At 640, the rewards engine 302 calculates a non-monetary point allocation associated with the campaign rule. In an example, the calculation of a non-monetary point allocation will be in association with an event the user can select. In some examples, the calculation of a non-monetary point allocation is associated with an event that the user has selected or an event that is in process. At 650, the method 600 continues with the reward engine 302 storing the non-monetary point allocation using the rewards earn events and tracking component 430. In certain examples, the rewards engine 302 can store the non-monetary point allocation within the data warehouse 306.

At 660, the method 600 optionally concludes with the rewards engine 302 prompting display the non-monetary point allocation via the rewards earn events and tracking component 430. In some examples, the rewards engine 302 can interface with the delivery sub-system 320 to facilitate display of the non-monetary points allocation.

FIG. 7 is a flowchart illustrating an example method 700 for creating a merchant campaign within a rewards program. In this example, the method 700 includes operations for creating or selecting a reward program at 710, optionally defining global settings for the reward program at 720, defining a merchant rewards campaign at 730, creating a campaign rule at 740, storing the campaign rule at 750, determining if additional campaign rules need to be created at 760, optionally setting a rewards limit associated with the campaign, and optionally setting earn and/or burn periods associated with the campaign at 780.

In an example, the method 700 begins at 710 with the merchant using the administrative interface 304 to select a rewards program. In certain examples, the network-based system 102 supports only a single rewards program, in these examples the merchant is not required to perform this operation. In some examples, the network-based system 102 supports any number of rewards programs with different parameters, such as earn and burn periods. In these examples, the merchant can choose an existing rewards program to work within or create a new rewards program tailored to meet the merchant's specific needs. FIG. 9 is an example user interface screen illustrating a rewards program summary. In an example, the administrative interface 304 can display a reward program summary, such as the one depicted in FIG. 9.

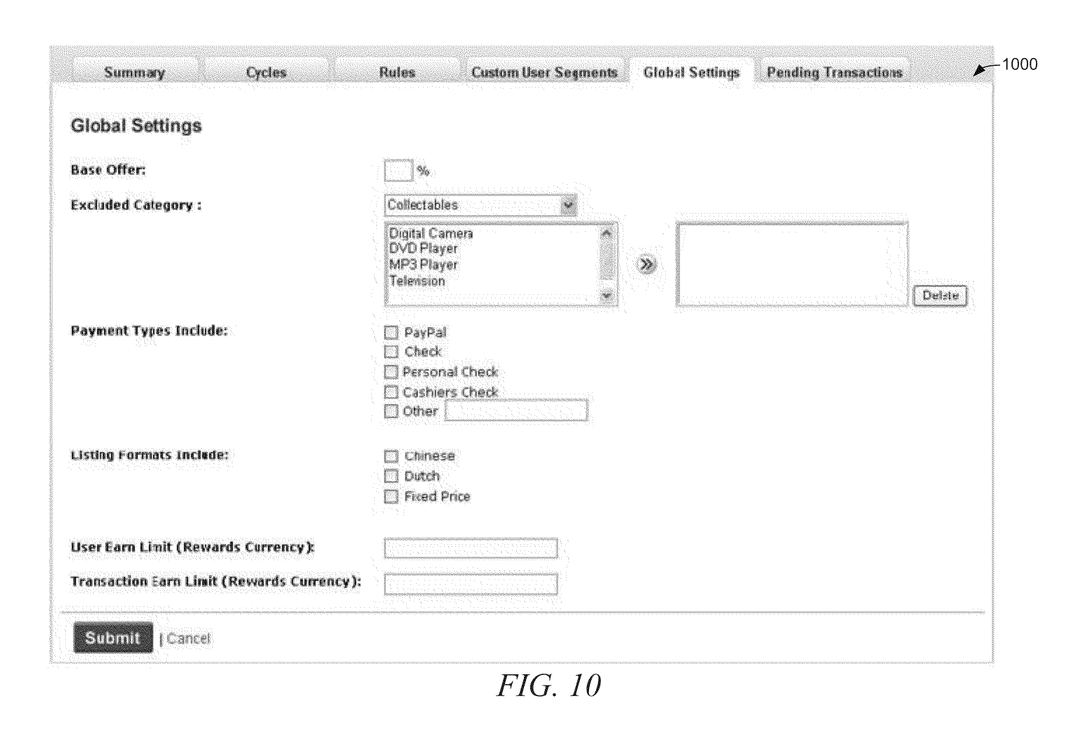

At 720, the method 700 optionally allows for configuration of global settings associated with the selected or created rewards program using the administrative interface 304. In an example, configuration of global rewards program settings is performed by administrative personnel operating the network-based system 102. In this example, individual merchants may not be able to perform configuration of rewards program global settings. Global settings associated with a rewards program can include included or excluded categories, payment types, listing formats, per user earn limits, and per transaction earn limits. FIG. 10 is an example user interface screen providing an interface for configuring global settings associated with a rewards program using the administrative interface 304.

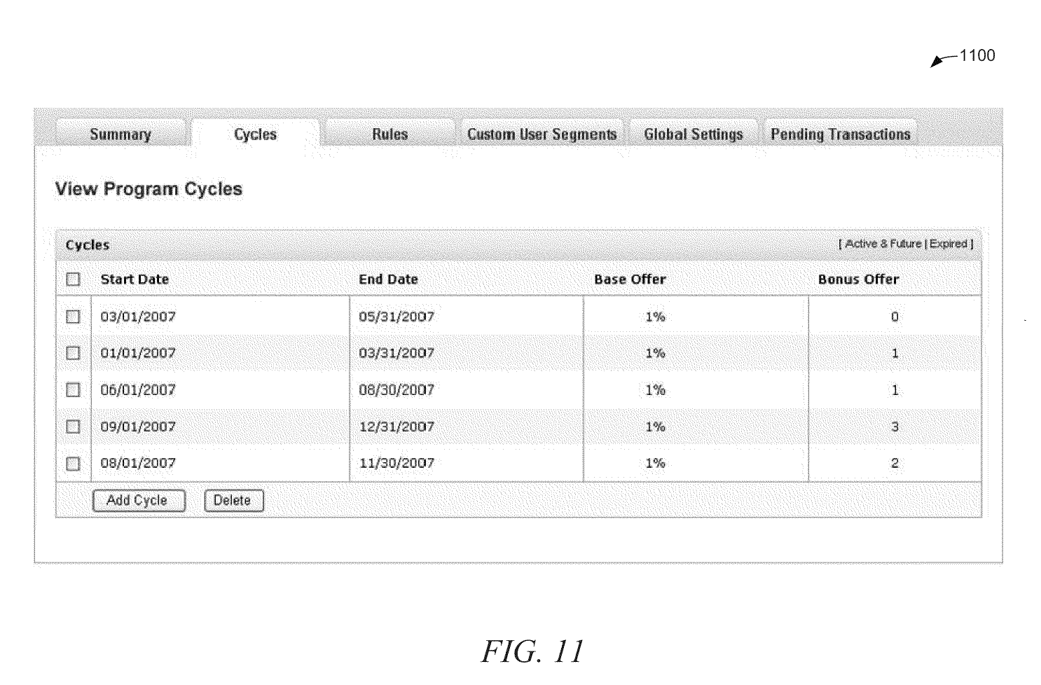

The method 700 continues at 730 with the merchant using the administrative interface 304 to define or add a campaign (also referred to as a cycle) to the rewards program. In an example, each campaign includes a base offer, such as 2% of purchases refunded in the form of non-monetary point allocations (e.g., rewards points). A campaign can be generally defined by the following basic parameters, a start date, an end date, a base offer, and one or more bonus offers. Campaigns can also have additional rules or qualifiers associated with them to further refine the users and events that will be targeted by the campaign. FIG. 11 is an example user interface screen 1100 that provides an interface for listing program cycles (campaigns) within a particular rewards program.

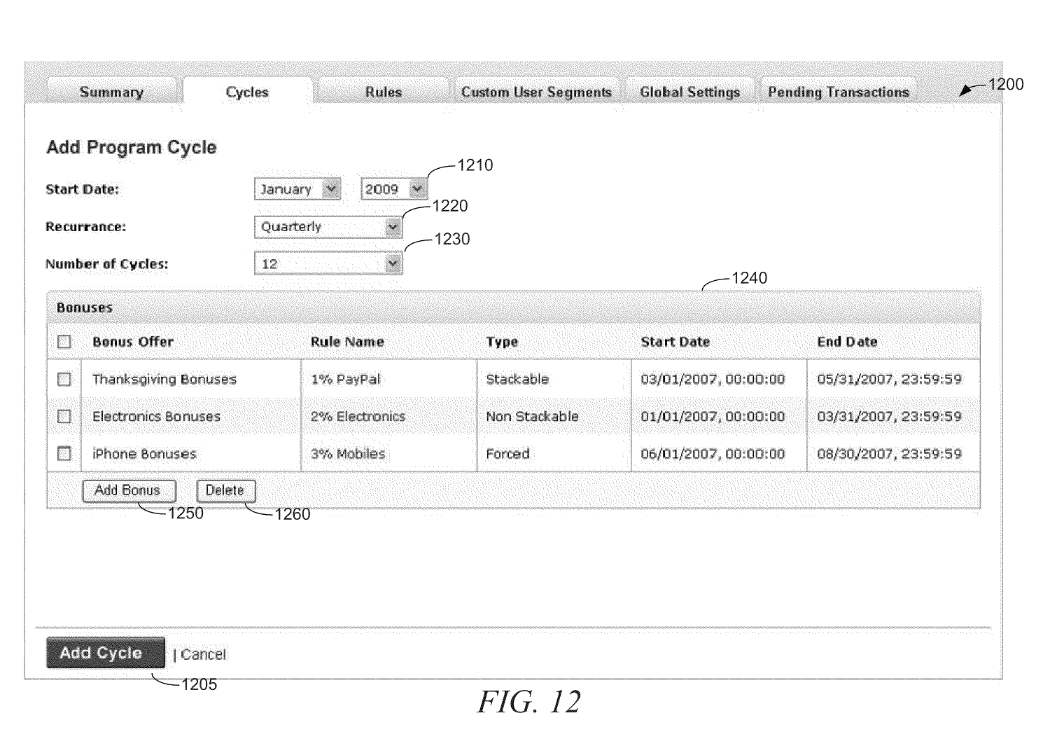

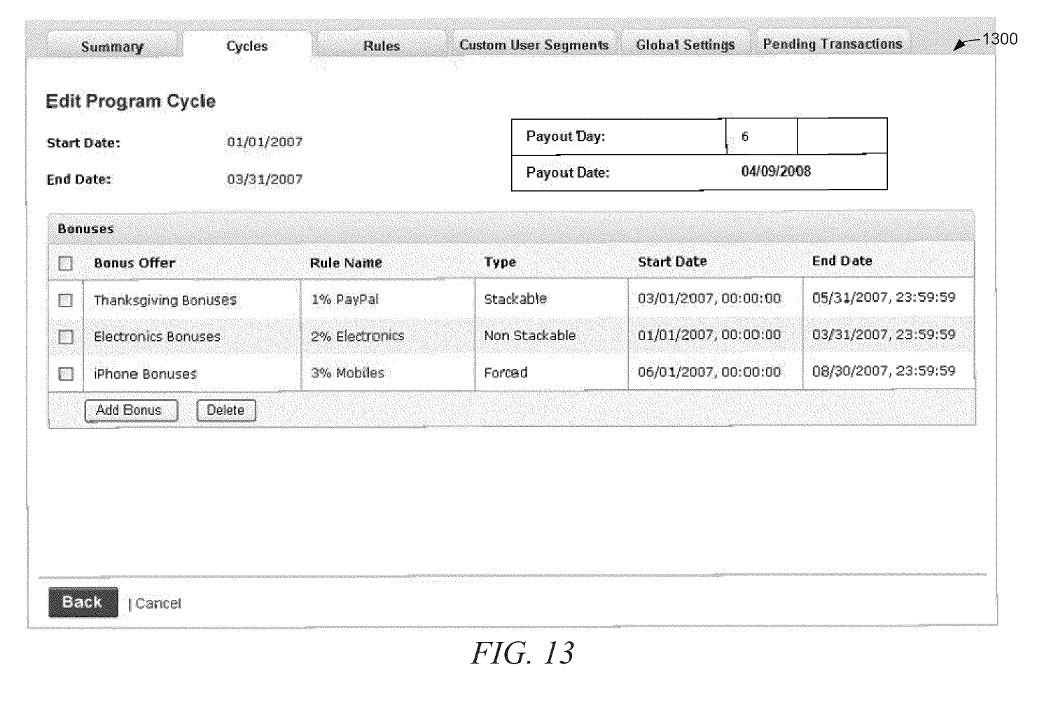

FIG. 12 is an example user interface screen 1200 that provides an interface for adding program cycles (campaigns). The user interface screen 1200 includes an add cycle button 1205, start date controls 1210, a recurrence control 1220, a number of cycles control 1230, a bonuses display 1240, an add bonus button 1250, and a delete bonus button 1260. The user interface screen 1200 can be used to configure the parameters of a program cycle (e.g., merchant campaign). The add bonus button 1250 can be used to add bonus offers within the program cycle. FIG. 13 is an example user interface screen 1300 that provides an interface for editing program cycles within a rewards program.

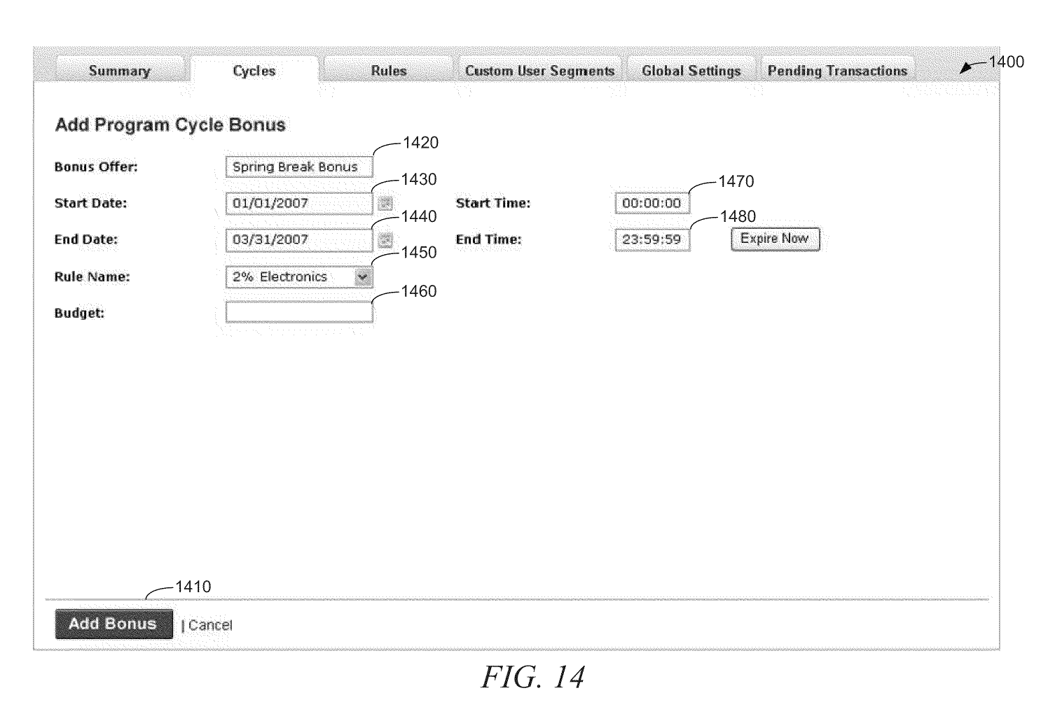

FIG. 14 is an example user interface screen 1400 that provides an interface for adding a program cycle bonus offer. In this example, the user interface screen 1400 includes an add bonus button 1410, a bonus offer text entry box 1420, a start date control 1430, an end date control 1440, a rule name dropdown list box 1450, a budget entry field 1460, a start time control 1470, and an end time control 1480. The various input fields and controls within the user interface screen 1400 can be used to add a bonus offer to a program cycle.

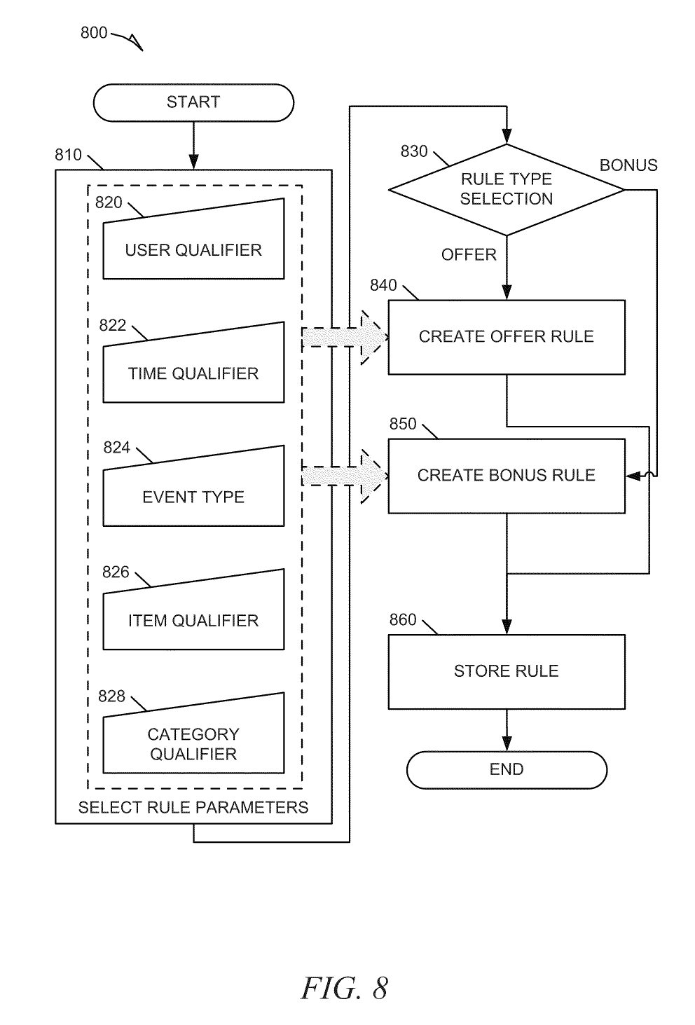

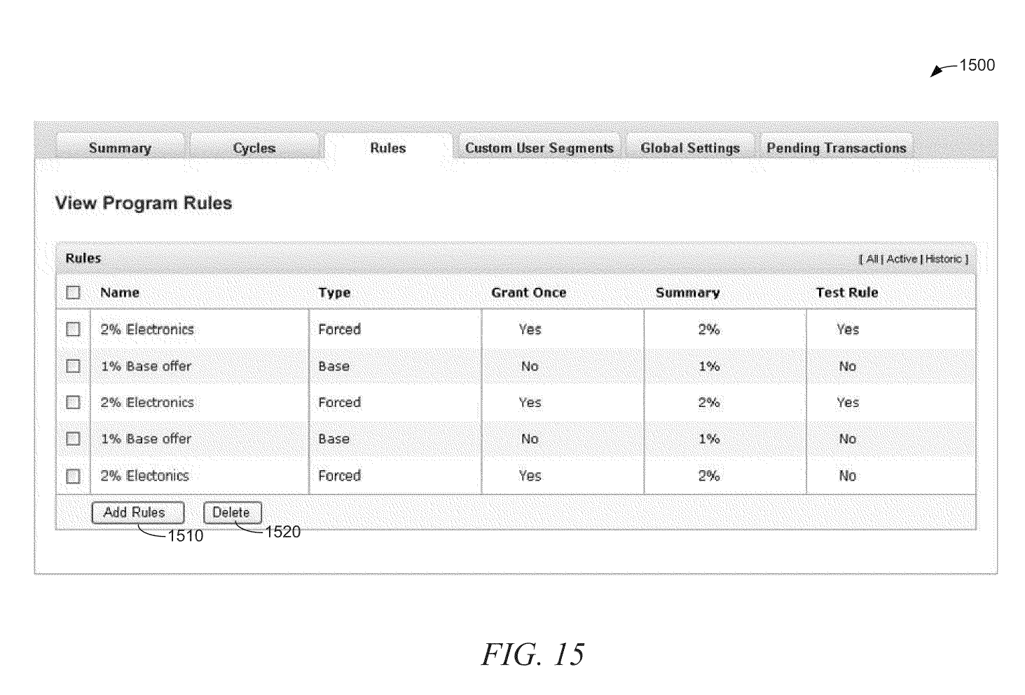

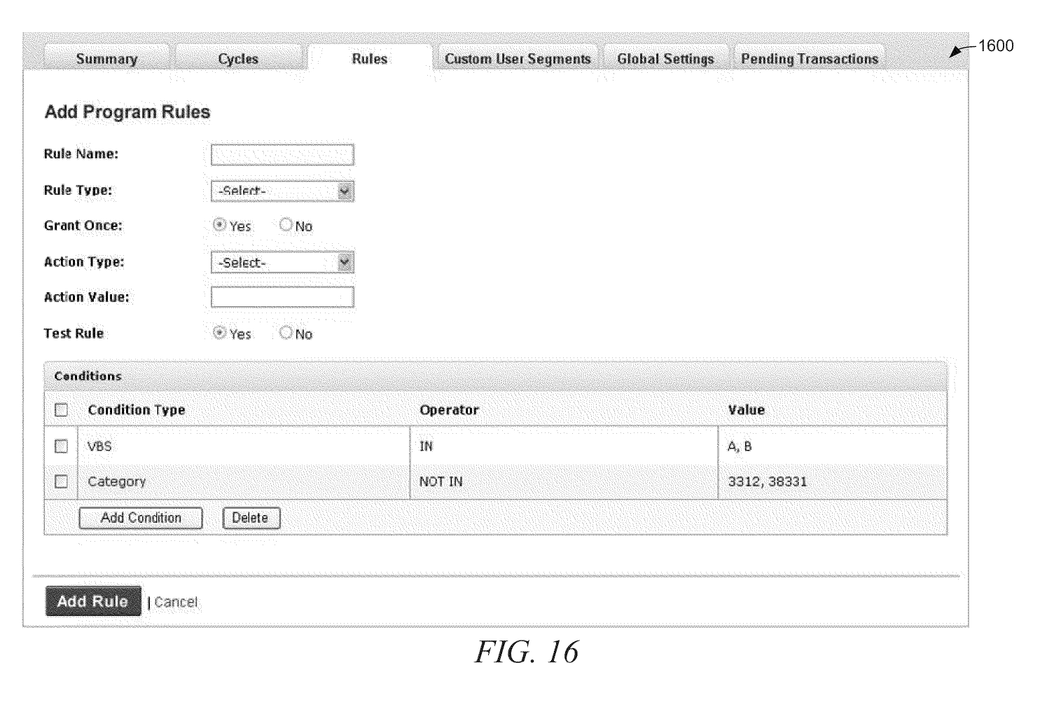

Returning to FIG. 7, the method 700 continues at 740 with the merchant using the administrative interface 304 to create campaign rules. In certain examples, the merchant may use the campaign rule creation module 420 to create the campaign rules. Campaign rule creation is described in more detail below in reference to FIG. 8. FIG. 15 is an example user interface screen 1500 that provides an interface to view campaign rules defined within the current program. The user interface screen 1500 includes an add rules button 1510 and a delete button 1520 to respectively add and remove rules. FIG. 16-18F are example user interface screens that provide various interfaces for adding and editing campaign rules within a rewards program.

Returning to FIG. 7, at 750, the method 700 continues with the merchant deciding whether any additional rules need to be added. If additional rule need to be created, the method 700 loops back to operation 740 and starts the rule creation process over for a new rule. If no additional rules need to be created, the method 700 continues with optional operations 770 and 780. At 770, the method 700 continues with the merchant optionally configuring rewards limits for the individual merchant campaign created at operation 730. At 780, the method 700 concludes with the merchant using the administrative interface to set earn and/or burn periods. An earn period defines the period of time users can accumulate non-monetary point allocations. The burn period defines a period of time users can redeem non-monetary point allocations earned during the earn period for stored value coupons or other discounts on additional purchases.

FIG. 8 is a flowchart illustrating an example method 800 for creating reward campaign offer and bonus rules. In this example, the method 800 includes operations for selecting rule parameters at 810, selecting the type of rule being created at 830, creating an offer rule at 840, creating a bonus rule at 850, and storing the rule at 860. In this example, the operation for selecting rule parameters 810 can include a user qualifier 820, a time qualifier 822, an event type 824, an item qualifier 826, and a category qualifier 828. In certain examples, the rewards engine 302 can support programmable qualifiers that enable greater flexibility than the built in rule parameters depicted in FIG. 8.

The method 800 begins at 810 with the administrative interface presenting the available campaign rule parameters to a merchant for selection. The user qualifier 820 can be configured to target a subset of users registered within the network-based system 102. In certain examples, the user qualifier can be configured to target guest users (e.g., unregistered users) as part of a campaign rule (see APPENDIX A for a listing of example user qualifiers). The time qualifier 822 can be configured to limit the amount of time a particular offer or bonus is available to users within the network-based system 102. The event type 824 can be used to define an event or user action that triggers the rewards engine 302 to calculate a non-monetary point allocation. For example, an event type may be a purchase action, a search request, payment action, or a combination of user actions (e.g., purchase plus payment). The event type 824 can include additional qualifiers, such as payment with a credit card for example. The item qualifier 826 can be used to target certain products or services with special offers or bonuses (see APPENDIX B for a listing of example item qualifiers). The category qualifier 828 allows entire categories of listings within a publication system, such as the network-based system 102 to be targeted with special offers or bonuses.

At 830, the method 800 continues with the administration interface 304 receiving selection of a rule type for the rule being configured. In this example, the rule defines how and when either an offer or a bonus is calculated. If the rule relates to an offer, the method 800 continues at 840 with the rewards engine creating the offer rule defined by the rule parameter selection at 810. If the rule relates to a bonus, the method 800 continues at 850 with the reward engine creating the bonus rule defined by the rule parameter selection at 810. At 860, the method 800 concludes with the rewards engine 302 storing the newly created rule.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

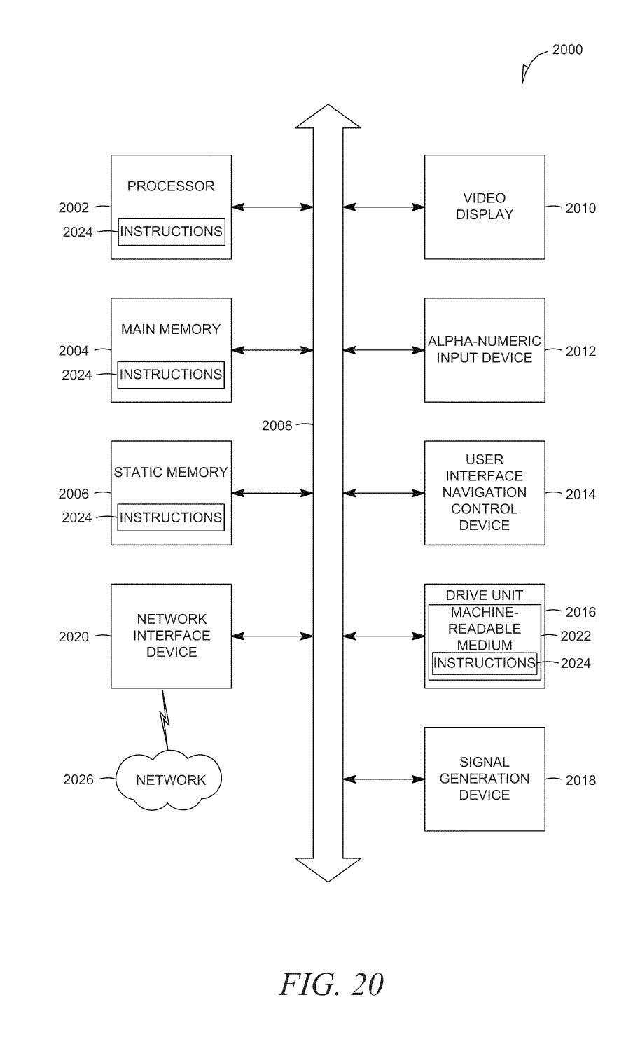

FIG. 20 is a block diagram of machine in the example form of a computer system 300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a user interface (UI) navigation device 2014 (e.g., a mouse), a disk drive unit 2016, a signal generation device 2018 (e.g., a speaker) and a network interface device 2020.

### Machine-Readable Medium

The disk drive unit 2016 includes a machine-readable medium 2022 on which is stored one or more sets of instructions and data structures (e.g., software) 2024 embodying or utilized by any one or more of the methodologies or functions described herein. The instructions 2024 may also reside, completely or at least partially, within the main memory 2004 and/or within the processor 2002 during execution thereof by the computer system 2000, the main memory 2004 and the processor 2002 also constituting machine-readable media.

While the machine-readable medium 2022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2024 may further be transmitted or received over a communications network 2026 using a transmission medium. The instructions 2024 may be transmitted using the network interface device 2020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system to provide a multi-merchant rewards platform have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The claimed invention is:

1. A method comprising:
receiving, within an online marketplace, a campaign rule from a merchant, the campaign rule including criterion, the criterion including a user qualifier and an event type;
identifying a user accessing the online marketplace, the user accessing the online marketplace from a remote computer system;
determining, while the user is accessing the online marketplace, whether the user satisfies at least one criterion included in the campaign rule;
calculating, using one or more processors, a non-monetary point allocation associated with the event type, the calculating based on determining that the user satisfies the user qualifier; and
storing, based on receiving input from the user selecting a user action associated with the event type, the non-monetary point allocation in a user account associated with the user.

2. The method claim 1, wherein the receiving the campaign rule includes receiving a user qualifier defining a buyer type, wherein the buyer type includes new buyers and repeat buyers and, wherein the new and repeat buyers are determined relative to the merchant.

3. The method of claim 1, wherein the receiving the campaign rule includes receiving a user qualifier defining a qualifying purchase history of the user.

4. The method of claim 3, wherein the qualifying purchase history of the user is determined based on a qualifying purchase history relative to the merchant.

5. The method of claim 1, wherein the event type is a purchase action.

6. The method of claim 1, wherein the event type includes a payment action.

7. The method of claim 1, further comprising storing the non-monetary point allocation in an account associated with the user, wherein the storing is based on receiving a selection of the user action.

8. The method of claim 7, wherein the storing the non-monetary point allocation is based on a promptness criterion associated with the receiving the selection of the user action, wherein the promptness criterion is defined within the campaign rule.

9. The method of claim 1, wherein the calculating the non-monetary point allocation includes determining a fixed amount non-monetary point allocation associated with the user action.

10. The method of claim 1, wherein the calculating the non-monetary point allocation includes calculating a percentage-based non-monetary point allocation, the percentage-based non-monetary point allocation calculated based on a percentage of a monetary value associated with the user action.

11. The method of claim 1, wherein the calculating the non-monetary point allocation includes determining an availability of stackable non-monetary point allocations associated with the available user action.

12. The method of claim 1, wherein the calculating the non-monetary point allocation includes determining a multiplier, wherein the multiplier is selected from a group of multipliers consisting of a multiplier associated with the user and a multiplier associated with the user action, the multiplier used to multiply the non-monetary point allocation.

13. The method of claim 1, further comprising displaying the non-monetary point allocation in proximity to a graphical representation of the user action associated with the event type.

14. A system comprising:
a processor-implemented administration interface to receive a campaign rule from a merchant registered within an online marketplace;
a processor-implemented user tracking module to identify a user accessing the online marketplace, the user accessing the online marketplace from a remote computer system;
a processor-implemented rewards engine to,
determine, while the user is accessing the online marketplace, whether the user satisfies the campaign rule; and
calculate, based on the determination that the user satisfies the campaign rule, a non-monetary point allocation associated with a user action;
receive input from the user indicating selection of the user action; and
a database coupled to the rewards engine, the database to store the non-monetary point allocation associated with the user action.

15. The system of claim 14, wherein the processor-implemented administration interface receives a user qualifier portion of the campaign rule, the user qualifier defines a buyer type, wherein the buyer type includes new buyers and repeat buyers and the new and repeat buyers are determined relative to the merchant.

16. The system of claim 14, wherein the processor-implemented administration interface receives a user qualifier portion of the campaign rule, the user qualifier defines a qualifying purchase history associated with the user.

17. The system of claim 16, wherein the processor-implemented rewards engine calculates the qualifying purchase history associated with the user relative to the merchant.

18. The system of claim 14, wherein the processor-implemented rewards engine receives a purchase action as the user action.

19. The system of claim 14, wherein the processor-implemented rewards engine receives a payment action as the user action.

20. The system of claim 19, further comprising a database to store the non-monetary point allocation in association with the user, the storing based on receiving a selection by the user of the user action.

21. The system of claim 20, wherein the rewards engine stores the non-monetary point allocation based on a promptness criterion associated with the receiving the selection by the user of the user action, wherein the promptness criterion is received by the administration interface as part of the campaign rule.

22. The system of claim 14, wherein the rewards engine calculates the non-monetary point allocation based on a fixed amount associated with the user action.

23. The system of claim 14, wherein the rewards engine calculates the non-monetary point allocation based on a percentage of a monetary value associated with the user action

24. The system of claim 14, wherein the rewards engine is to:
determine whether the non-monetary point allocation associated with the user action is stackable;
determine whether any additional non-monetary point allocations are available associated with the user action; and
calculate the non-monetary point allocation based on all stackable non-monetary point allocations available associated with the user action.

25. The system of claim 14, wherein the rewards engine determines whether a non-monetary point allocation multiplier is selected from a group of multipliers consisting of a multiplier associated with the user and a multiplier associated with the user action, and the rewards engine calculates the non-monetary point allocation based on the non-monetary point allocation multiplier.

26. The system of claim 14 further comprising, a display sub-system to display the non-monetary point allocation in proximity to a graphical representation of the user action.

27. A machine-readable medium storing instructions, which when executed by one or more processors perform the following operations:
receive a campaign rule from a merchant registered within an online marketplace;
identify a user accessing the online marketplace, the user accessing the online marketplace from a remote computer system;
determine, while the user is accessing the online marketplace, whether the user satisfies the campaign rule;
calculate, based on the determination that the user satisfies the campaign rule, a non-monetary point allocation associated with a user action available to the user;
store, based on receiving input from the user selecting the user action, the non-monetary point allocation.
